(19) United States
(12) Patent Application Publication
(10) Pub. No.: US 2025/0290357 A1
(43) Pub. Date: Sep. 18, 2025

(54) DOOR HANDLE DEVICE

(71) Applicant: Minebea AccessSolutions Inc., Miyazaki-shi (JP)

(72) Inventors: Yuki YAMAMURA, Miyazaki (JP); Takahiro YAMADA, Miyazaki (JP); Tatsuya OOYAMA, Miyazaki (JP)

(21) Appl. No.: 19/072,131

(22) Filed: Mar. 6, 2025

(30) Foreign Application Priority Data
Mar. 12, 2024 (JP) 2024-038090

(51) Int. Cl. E05B 85/10; E05B 17/18; E05B 85/06; E05B 85/16

(52) U.S. Cl. CPC E05B 85/103; E05B 17/18; E05B 85/06; E05B 85/16

(57) ABSTRACT

A door handle device includes a base including a handle arrangement portion and a cylinder arrangement portion, a handle rotatably attached to the handle arrangement portion, a key cylinder attached to the cylinder arrangement portion, and a cover attached to the cylinder arrangement portion. The cover includes a cover main body and an attachment portion, and the cylinder arrangement portion is provided with an attachment hole. As seen along a direction in which an axis line A of a through-hole extends, the attachment hole is provided such that at least a part thereof is positioned between a first reference line passing through an upper end of the through-hole and extending in a left-right direction and a second reference line passing through a lower end of the through-hole and extending in the left-right direction.

### CROSS REFERENCE TO RELATED APPLICATION

This application claims benefit of priority to Japanese Patent Application 2024-038090, filed March 12, 204, the entire content of which is incorporated herein by reference.

### BACKGROUND

### Technical Field

The present invention relates to a door handle device.

### Background Art

A door latch device and a door handle device are attached to a door of a vehicle. The door latch device includes a latch mechanism and is switchable between a latched state in which the door is held in a closed state with respect to a vehicle body and an unlatched state in which the door can be opened with respect to the vehicle body. The door latch device further includes a lock mechanism and is switchable between an unlocked state in which the latch mechanism is switchable from the latched state to the unlatched state and a locked state in which the latch mechanism is not switchable from the latched state to the unlatched state. The latch mechanism and the lock mechanism are operated by the door handle device.

A door handle device disclosed in FR 2819539 B includes a handle and a key cylinder rotatably attached to a base. By operating a handle, a latch mechanism of a door latch device is switched from a latched state to an unlatched state. By operating a key cylinder using a mechanical key, a lock mechanism of the door latch device is switched from a locked state to an unlocked state.

The key cylinder disclosed in FR 2819539 B is arranged adjacent to the handle and is covered and concealed by a cover when not operated. In order to prevent the cover from detaching from the base when operating the key cylinder, the cover is provided with an attachment piece, and a cylinder arrangement portion of the base is provided with an attachment hole to which the attachment piece can be attached.

### SUMMARY

In FR 2819539 B, the attachment hole of the cover is provided at a distance below a through-hole of the cylinder arrangement portion through which the key cylinder is exposed. Therefore, there is a disadvantage in that the cover and the cylinder arrangement portion of the base become larger. That is, FR 2819539 B does not take any consideration into the miniaturization of the cover that covers the key cylinder and the cylinder arrangement portion of the base.

The present invention relates to a door handle device for operating a door latch device and an object thereof is to downsize a cover of a key cylinder and a cylinder arrangement portion of a base.

The present invention provides a door handle device including a base including a handle arrangement portion and a cylinder arrangement portion and to be attached to a door, the cylinder arrangement portion provided adjacent to the handle arrangement portion and including a through-hole penetrating from a vehicle exterior side to a vehicle interior side; a handle rotatably attached to the handle arrangement portion so as to be exposed to a vehicle exterior side of the door and configured to operate a door latch device attached to the door to open; a key cylinder attached to the cylinder arrangement portion such that a keyhole is exposed to the vehicle exterior side via the through-hole and configured to operate the door latch device to unlock; and a cover attached to the vehicle exterior side of the cylinder arrangement portion, in which the cover includes a cover main body configured to exposably cover the keyhole including the through-hole, and an attachment portion protruding from the cover main body, the cylinder arrangement portion is provided with an attachment hole for attaching the attachment portion, and the attachment hole is provided such that at least a part of the attachment hole is positioned between a first reference line passing through an upper end of the through-hole and extending in a left-right direction and a second reference line passing through a lower end of the through-hole and extending in the left-right direction or between a third reference line passing through a left end of the through-hole and extending in an upper-lower direction and a fourth reference line passing through a right end of the through-hole and extending in the upper-lower direction, as seen along a direction in which an axis line of the through-hole extends.

The attachment hole for attaching the attachment portion of the cover is provided such that at least a part of the attachment hole is positioned between the first reference line passing through the upper end of the through-hole through which the keyhole is exposed and the second reference line passing through the lower end of the through-hole or between the third reference line passing through the left end of the through-hole and the fourth reference line passing through the right end of the through-hole. For this reason, the cover main body can be made as small as possible within a range in which the through-hole including the keyhole of the key cylinder can be covered. Therefore, an occupying area necessary to form the cylinder arrangement portion can also be made as narrow as possible within a range in which the cover can be arranged. As a result, the cover of the key cylinder and the cylinder arrangement portion of the base can be downsized, and thus the entire door handle device can be downsized.

According to the present invention, in the door handle device for operating the door latch device, the cover of the key cylinder and the cylinder arrangement portion of the base can be downsized.

### BRIEF DESCRIPTION OF DRAWINGS

FIG. 1 is a block diagram of a door handle device and a door lock device according to an embodiment of the present invention.

FIG. 2 is a perspective view of the door handle device viewed from the front side.

FIG. 3 is a cross-sectional view taken along line III-III of FIG. 2.

FIG. 4 is a perspective view of the door handle device from which a cover is removed, viewed from the rear side.

FIG. 5 is a perspective view illustrating a state in which the cover of FIG. 2 is opened.

FIG. 6 is a perspective view illustrating a handle and the cover disassembled with respect to a base.

FIG. 7 is a rear perspective view illustrating the cover disassembled with respect to the base.

FIG. 8 is a view illustrating a cylinder arrangement portion of the base and the cover.

FIG. 9 is a rear perspective view of the cover.

FIG. 10 is a rear view illustrating a state in which a through-hole is covered with the cover.

### DETAILED DESCRIPTION

Hereinafter, an embodiment of the present invention will be described with reference to the drawings.

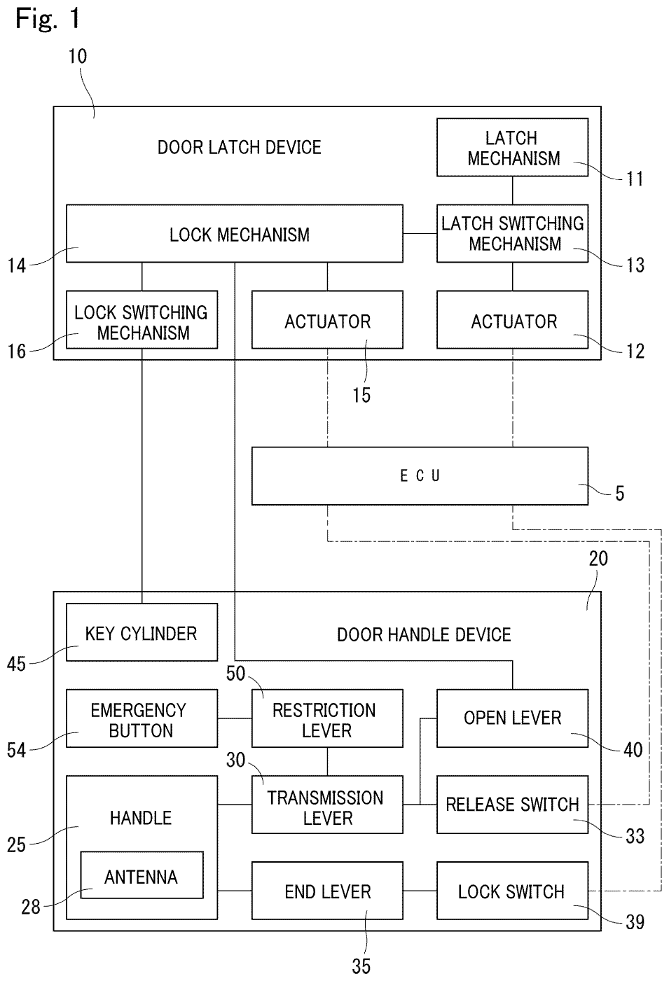

Referring to FIGS. 1 to 3, a door handle device 20 according to an embodiment of the present invention is attached to an outer panel (door panel) 2 of a door 1, and enables the door 1 in a closed state to be opened by operating a door latch device 10 attached to the same door 1. The door handle device 20 of the present embodiment is for a left side door in which a hinge shaft extends in a vehicle height direction. However, the door handle device 20 may also be used for a right side door, a slide door, or a back door.

An X direction in the accompanying drawings is a vehicle length direction, a direction indicated by an arrow is a rear side, and a direction opposite to the arrow is a front side. A Y direction is a vehicle width direction, a direction indicated by an arrow is an inner side (vehicle interior side), and a direction opposite to the arrow is an outer side (vehicle exterior side). A Z direction is a vehicle height direction, a direction indicated by an arrow is an upper side, and a direction opposite to the arrow is a lower side.

Referring to FIG. 1, the door handle device 20 is connected to an electronic control unit (ECU) 5 mounted on a vehicle. The ECU 5 includes a calculation unit, a storage unit, and a communication unit (none of which are illustrated), reads out a program stored in advance in the storage unit, and executes information processing according to steps instructed by the program. A door latch device 10 is further connected to the ECU 5. The ECU 5 electrically actuates the door latch device 10 based on an input signal from the door handle device 20.

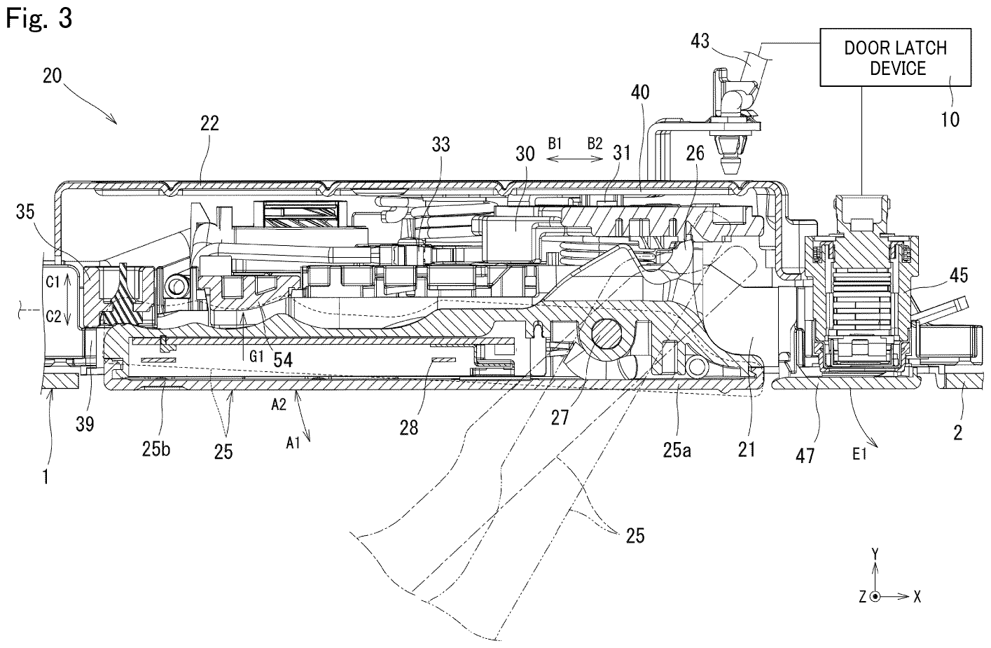

Describing the outline of the door latch device 10, the door latch device 10 is arranged along an end panel (not illustrated) of the door 1 illustrated in FIG. 3. The door latch device 10 includes a latch mechanism 11, an actuator 12, a latch switching mechanism 13, a lock mechanism 14, an actuator 15, and a lock switching mechanism 16.

The latch mechanism 11 includes a fork and a claw, and is switched between a latched state and an unlatched state. In the latched state, the fork holds a striker of the vehicle body and holds the door 1 illustrated in FIG. 3 in a closed state. In the unlatched state, the fork releases the striker, enabling the door 1 to be opened.

Switching of the latch mechanism 11 from the unlatched state to the latched state is performed by entry of the striker into the fork due to closing of the door 1 in the open state. Switching (opening actuation) of the latch mechanism 11 from the outside of the vehicle from the latched state to the unlatched state is performed by an operation of the door handle device 20, but is different between a normal state in which the latch mechanism 11 can be electrically actuated by the actuator 12 via the latch switching mechanism 13 and an emergency state in which the latch mechanism 11 cannot be actuated. Switching of the latch mechanism 11 by the operation of the door handle device 20 will be described in detail below.

The lock mechanism 14 is configured by a plurality of levers and the like, and is switched between an unlocked state and a locked state. In the unlocked state, the latch mechanism 11 can be switched from the latched state to the unlatched state via the latch switching mechanism 13. In the locked state, the latch mechanism 11 cannot be switched from the latched state to the unlatched state via the latch switching mechanism 13.

Switching of the lock mechanism 14 from the outside of the vehicle from the unlocked state to the locked state is performed by an operation of the door handle device 20. Switching of the lock mechanism 14 from the outside of the vehicle from the locked state to the unlocked state is performed by an operation of the door handle device 20, but is different between a normal state in which the lock mechanism 14 can be electrically actuated by the actuator 15 and an emergency state in which the lock mechanism 14 cannot be actuated. Switching of the lock mechanism 14 by the operation of the door handle device 20 will be described in detail below.

Below, the door handle device 20 according to the present embodiment will be specifically described.

The door handle device 20 includes a configuration for electrically actuating the door latch device 10 illustrated in FIG. 1 by the ECU 5 in a normal state and manually actuating the same in an emergency state. Specifically, as illustrated in FIGS. 1 to 4, the door handle device 20 includes a base 21, a cover 22, a handle 25, and a transmission lever 30. In addition, the door handle device 20 includes a release switch 33, an end lever 35, a lock switch 39, an open lever 40, a key cylinder 45, a restriction lever 50, and an emergency button 54.

The handle 25 is a flush handle elongated in the vehicle length direction and extending flush with the outer panel 2 and is rotationally operated both in a normal state and in an emergency state. The handle 25 is provided with an operation portion 26 that protrudes inward in the vehicle width direction and operates the transmission lever 30. The transmission lever 30 is arranged adjacent to a vehicle interior side of the handle 25, includes an operation receiving portion 30a that receives an operation by the operation portion 26, and rotates in conjunction with the rotation of the handle 25 both in a normal state and in an emergency state.

The release switch 33 is a detection unit for actuating the latch mechanism 11 and the lock mechanism 14 illustrated in FIG. 1 in a normal state and is arranged adjacent to the transmission lever 30. The end lever 35 and the lock switch 39 are configured to actuate the lock mechanism 14 illustrated in FIG. 1 in a normal state and are arranged on the vehicle interior side of a front end portion of the handle 25 in the vehicle length direction.

The open lever 40 is configured to rotate in conjunction with the rotation of the transmission lever 30 in an emergency state to actuate the latch mechanism 11 illustrated in FIG. 1 and is arranged below the transmission lever 30. The key cylinder 45 is configured to actuate the lock mechanism 14 illustrated in FIG. 1 in an emergency state and is arranged adjacent to the rear side of the handle 25 in the vehicle length direction.

The restriction lever 50 is configured to restrict transmission of an operating force of the handle 25 to the latch mechanism 11 illustrated in FIG. 1 via the open lever 40 by restricting rotation of the handle 25 via the transmission lever 30 in a normal state. The emergency button 54 is configured to release restriction by the restriction lever 50 in an emergency.

The control of the door latch device 10 by the ECU 5 illustrated in FIG. 1 is executed when authentication with an electronic key (not illustrated) carried by a user is established. That is, in a normal state, when the authentication with the electronic key is not established, the operation of the door latch device 10 by the ECU 5 is not executed. An antenna 28 for the ECU 5 to wirelessly communicate with the electronic key is accommodated in the handle 25.

Below, an operation including the door latch device 10 according to the operation of the door handle device 20 will be described.

### Opening Operation in Normal State

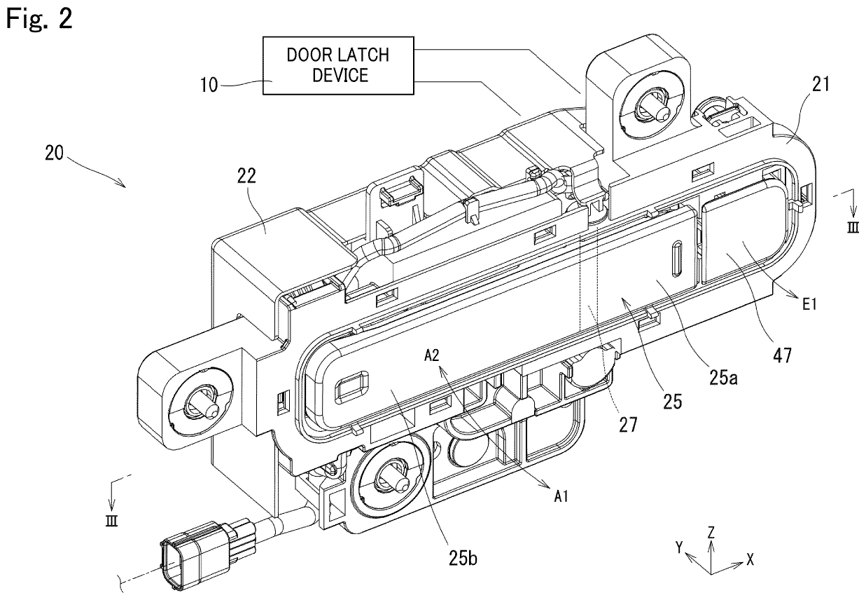

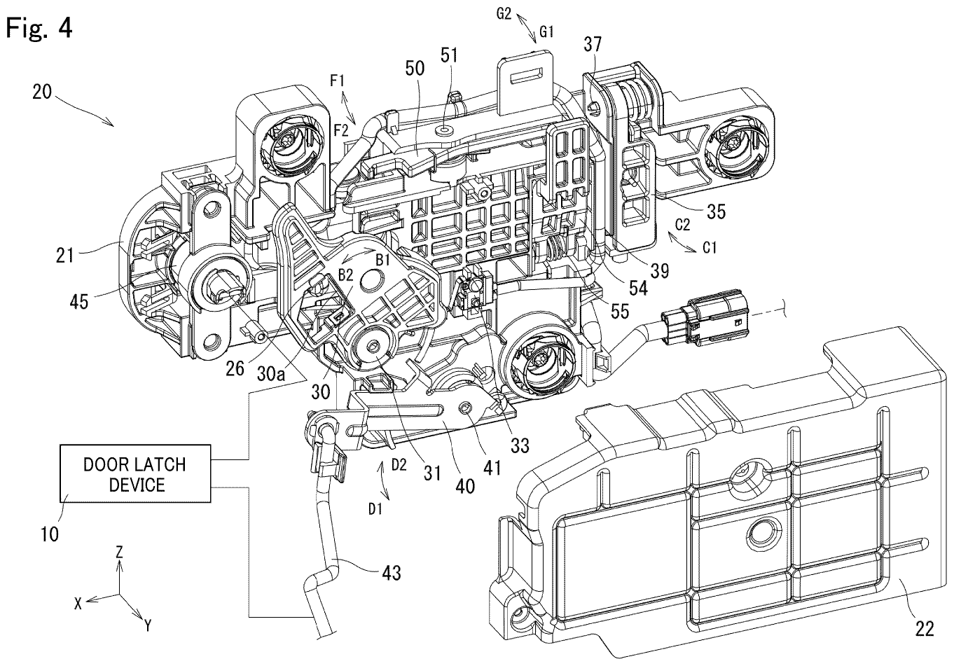

When operating the door latch device 10 to open in a normal state, a portion 25a, which is positioned on the rear side of a rotary shaft 27, of the handle 25 at the initial position indicated by a solid line in FIG. 3 is pushed inward in the vehicle width direction. As a result, the handle 25 rotates in a direction A1 in FIG. 2, and the transmission lever 30 pivotally supported by a rotary shaft 31 rotates in a direction B1 in FIG. 4. By the rotation of the transmission lever 30, the release switch 33 is switched from an off state to an on state and outputs an opening signal. As a result, the ECU 5 illustrated in FIG. 1 electrically switches the lock mechanism 14 from the locked state to the unlocked state by the actuator 15, and then electrically switches the latch mechanism 11 from the latched state to the unlatched state via the latch switching mechanism 13 by the actuator 12. Thus, the door 1 illustrated in FIG. 3 can be opened.

The rotation of the handle 25 by the operation of the rear-side portion 25a is restricted at a normal operation position indicated by the dash-dot line in FIG. 3 due to the contact of the transmission lever 30 with the restriction lever 50. In this restricted state, the release switch 33 of the transmission lever 30 can be operated as described above, but the open lever 40 cannot be operated (pressed). That is, the operating force of the handle 25 is not transmitted to the open lever 40 via the transmission lever 30 in the normal state. As a result, it is possible to prevent the electric switching and manual switching of the latch mechanism 11 from competing with each other to cause a malfunction in the door latch device 10.

### Lock Operation in Normal State

When the door latch device 10 is operated in a normal state, a portion 25b, which is positioned on the front side of the rotary shaft 27, of the handle 25 at the initial position is pushed inward in the vehicle width direction. As a result, the handle 25 rotates in a direction A2 toward a normal lock operation position indicated by the broken line in FIG. 3, and the end lever 35 pivotally supported by the rotary shaft 37 rotates in a direction C1 in FIG. 3. By the rotation of the end lever 35, the lock switch 39 is switched from an off state to an on state and outputs a lock signal. As a result, the ECU 5 illustrated in FIG. 1 electrically switches the lock mechanism 14 from the unlocked state to the locked state by the actuator 15. Thus, the door 1 illustrated in FIG. 3 cannot be opened.

### Opening Operation in Emergency State

An opening operation of the door latch device 10 in an emergency state is performed in the order of an unlocking operation of the lock mechanism 14 and an unlatching operation of the latch mechanism 11 illustrated in FIG. 1.

When unlocking the door latch device 10 in an emergency state, the cover 47 in FIG. 2 is operated in a direction E1, which is an outer side in the vehicle width direction, and a keyhole of the key cylinder 45 is exposed to the outside of the vehicle. Thereafter, a mechanical key (not illustrated) is inserted into the key cylinder 45 and rotationally operated. As a result, the lock mechanism 14 to which the operating force is transmitted via a transmission member (not illustrated) and the lock switching mechanism 16 illustrated in FIG. 1 is manually switched from the locked state to the unlocked state.

Subsequently, when the door latch device 10 is operated to open in an emergency state, the rear-side portion 25a of the handle 25 is pushed inward in the vehicle width direction. As a result, the handle 25 rotates in the direction A1 in FIG. 2, and the transmission lever 30 rotates in the direction B1 in FIG. 4. However, in an emergency state, the latch mechanism 11 cannot be electrically actuated to open. In addition, the rotation of the handle 25 by the operation of the rear-side portion 25a is restricted at the normal operation position indicated by the dash-dot line in FIG. 3 due to the contact of the transmission lever 30 with the restriction lever 50 in the same manner as the operation in a normal state.

Next, in an emergency state, the emergency button 54 exposed by the rotation of the handle 25 is pushed inward in the vehicle width direction. As a result, the emergency button 54 pivotally supported by the rotary shaft 55 rotates in a direction G1 in FIG. 4, and the restriction lever 50 pivotally supported by the rotary shaft 51 rotates in a direction F1 away from the transmission lever 30 in FIG. 4. As a result, the rotational restriction of the transmission lever 30 in the direction B1 by the restriction lever 50 is released.

By releasing the restriction of the transmission lever 30, the handle 25 can be rotated in the direction A1 to an emergency operation position illustrated by the two-dot chain line in FIG. 3. By this operation, the transmission lever 30 is further rotated in the direction B1 in FIG. 4 to press the open lever 40. As a result, the open lever 40 pivotally supported by the rotary shaft 41 rotates in a direction D1, which is a lower side in FIG. 4. As a result, the operating force of the handle 25 is transmitted to the latch mechanism 11 via the transmission lever 30, the open lever 40, a rod 43, the lock mechanism 14 illustrated in FIG. 1, and the latch switching mechanism 13, and the latch mechanism 11 is manually switched from the latched state to the unlatched state. As a result, the door 1 illustrated in FIG. 3 can be opened.

In the door handle device 20 configured as described above, in the present embodiment, it is intended to downsize a portion of the base 21 where the key cylinder 45 is arranged (cylinder arrangement portion 21b) and the cover 47 that covers the key cylinder 45.

Below, configurations of the base 21, the handle 25, the key cylinder 45, and the cover 47 will be specifically described.

Referring to FIG. 3, the base 21 is attached to a vehicle interior side with respect to an outer panel 2. The handle 25 and the cover 47 are attached to the vehicle exterior side with respect to the base 21 and are exposed to the vehicle exterior side via a through-hole of the outer panel 2. The key cylinder 45 is attached to the base 21 so as to be positioned inward of the cover 47 in the vehicle width direction. The other transmission lever 30, restriction lever 50, and emergency button 54 are all attached to the vehicle interior side with respect to the base 21 and covered by the cover 22.

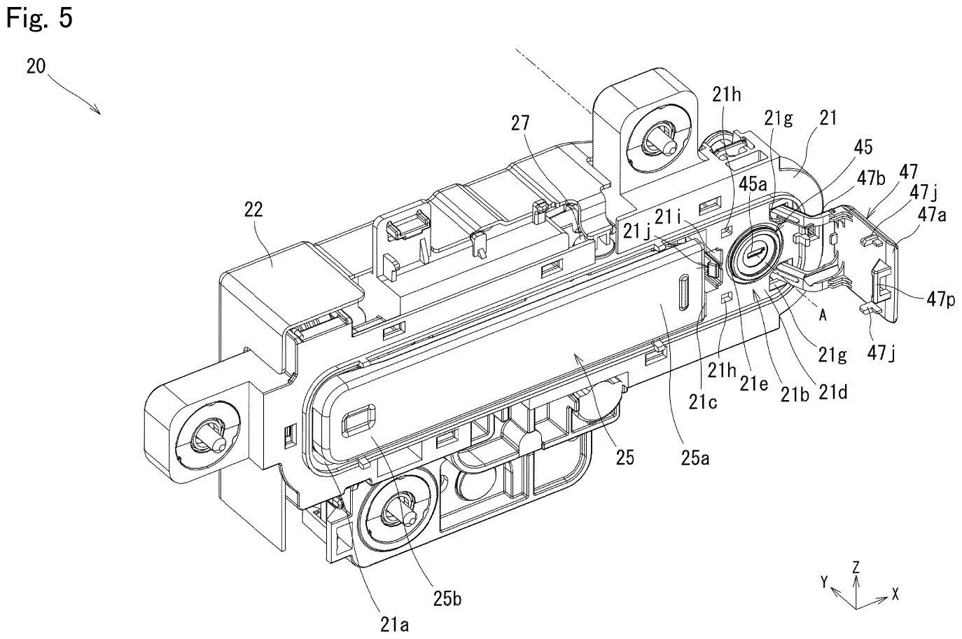

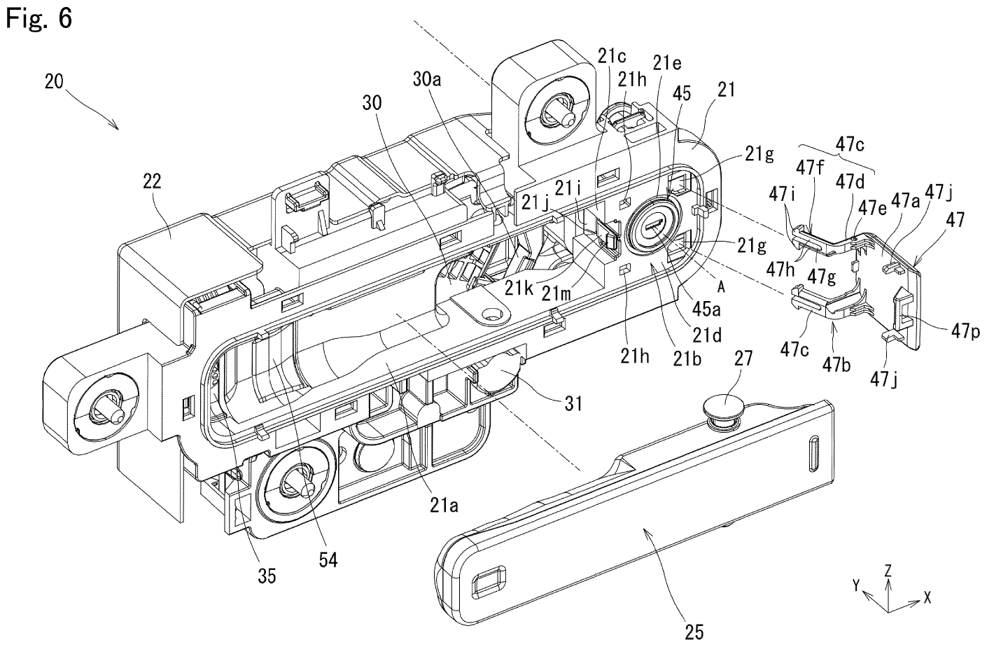

Referring to FIGS. 5 and 6, the base 21 includes a handle arrangement portion 21a and a cylinder arrangement portion 21b, which are provided adjacent to each other in the vehicle length direction.

The handle arrangement portion 21a is configured by a recessed groove recessed inward from the outer side in the vehicle width direction and extending in the vehicle length direction. A through-hole through which the operation portion 26 (see FIG. 3) of the handle 25 penetrates to the vehicle interior side is provided on the rear side, in the vehicle length direction, of the handle arrangement portion 21a. The end lever 35 and the emergency button 54 are arranged on a front side, in the vehicle length direction, of the handle arrangement portion 21a, which is exposed when the handle 25 is rotated to the normal operation position indicated by the dash-dot line in FIG. 3.

The cylinder arrangement portion 21b is provided adjacent to the rear side, in the vehicle length direction, of the handle arrangement portion 21a. The cylinder arrangement portion 21b is partitioned from the handle arrangement portion 21a by a partition wall 21c extending in the vehicle width direction and the vehicle height direction. Further, the cylinder arrangement portion 21b includes an outer wall 21d continuous with an end portion of the partition wall 21c on the outer side in the vehicle width direction and extending in the vehicle length direction and the vehicle height direction.

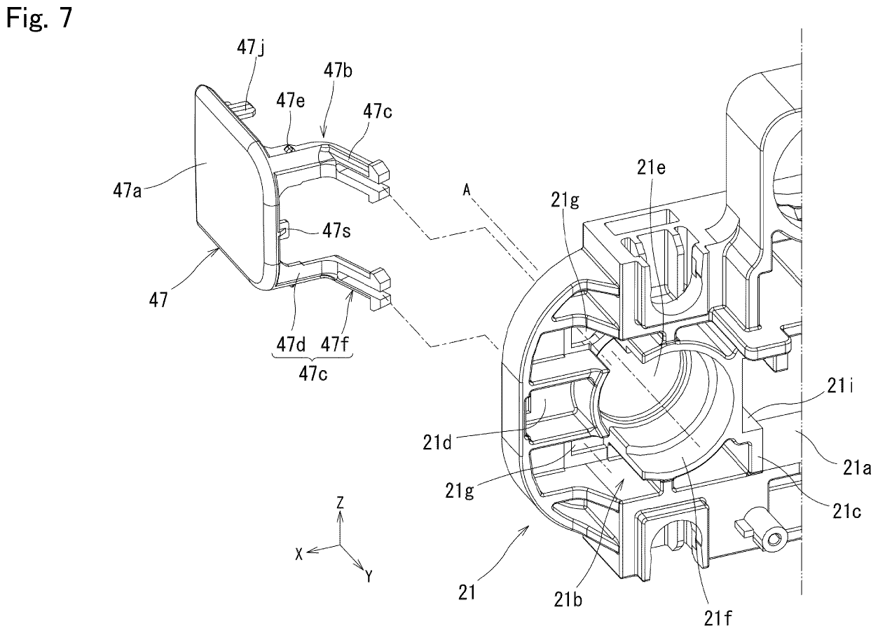

The outer wall 21d is provided with a through-hole 21e, which penetrates in the vehicle width direction from the vehicle exterior side to the vehicle interior side and through which a keyhole 45a of the key cylinder 45 is exposed to the vehicle exterior side. The through-hole 21e has a circular shape and has an axis line A extending in the vehicle width direction. However, the shape of the through-hole 21e may be a shape other than a circular shape. Referring to FIG. 7, an attachment frame 21f for attaching the key cylinder 45 is provided on the vehicle interior side of the through-hole 21e. The attachment frame 21f protrudes inward in the vehicle width direction from a hole edge of the through-hole 21e in a substantially cylindrical shape.

Referring to FIGS. 5 to 7, the outer wall 21d of the handle arrangement portion 21a is provided with a pair of attachment holes 21g and a pair of positioning holes 21h. The partition wall 21c is provided with a lock receiving portion 21j.

The attachment hole 21g penetrates the outer wall 21d in the vehicle width direction and movably attaches an attachment portion 47b of the cover 47. The pair of attachment holes 21g is provided on a rear side in the vehicle length direction, respectively, which is an opposite side to the handle arrangement portion 21a with respect to the through-hole 21e, and is arranged at an interval in the vehicle height direction.

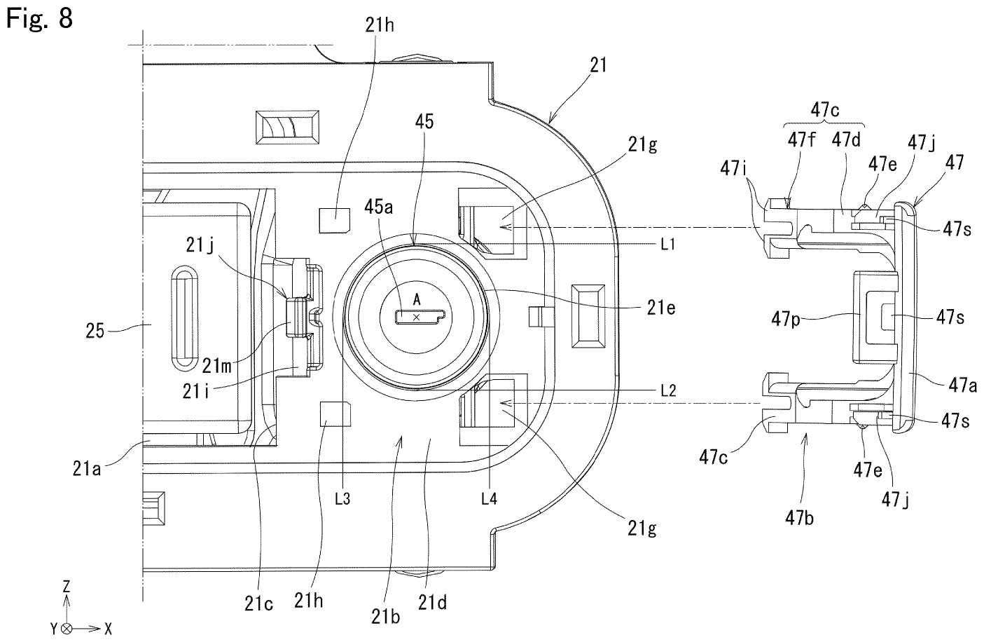

Referring to FIG. 8, when viewed from a direction in which the axis line A of the through-hole 21e extends, each of the pair of attachment holes 21g is provided such that a part thereof is positioned between a pair of reference lines L1 and L2 and the remaining part thereof is positioned outside the pair of reference lines L1 and L2. The first reference line L1 is defined as a tangential line passing through an upper end of the through-hole 21e and extending in the vehicle length direction (the left-right direction in FIG. 8). The second reference line L2 is defined as a tangential line passing through a lower end of the through-hole 21e and extending in the vehicle length direction. However, each of the attachment holes 21g may be provided such that the entire attachment hole is positioned between the pair of reference lines L1 and L2. That is, each of the attachment holes 21g may be provided such that at least a part thereof is positioned between the pair of reference lines L1 and L2.

Referring to FIGS. 6 and 8, the positioning hole 21h is provided to position the cover 47 in a state in which the through-hole 21e is closed by the cover 47. The positioning hole 21h has a substantially quadrangular shape and penetrates the outer wall 21d in the vehicle width direction. The pair of positioning holes 21h is provided on the handle arrangement portion 21a side, respectively, which is an opposite side (a front side in the vehicle length direction) to the attachment holes 21g with respect to the through-hole 21e, and is arranged at an interval in the vehicle height direction. Of the pair of positioning holes 21h, the upper positioning hole 21h is provided at the same height position as the upper attachment hole 21g, and the lower positioning hole 21h is provided at the same height position as the lower attachment hole 21g. More specifically, each of the positioning holes 21h is provided between an upper end and a lower end of the corresponding attachment hole 21g in the height direction.

The lock receiving portion 21j is provided to maintain a state in which the through-hole 21e is closed by the cover 47. The lock receiving portion 21j is provided on the handle arrangement portion 21a side of the partition wall 21c so as to be adjacent to the handle 25. More specifically, the partition wall 21c is provided with an insertion groove 21i recessed rearward from the front side in the vehicle length direction and extending in the vehicle width direction. The lock receiving portion 21j is provided in the insertion groove 21i. The lock receiving portion 21j includes an elastic piece 21k having a cantilever structure. An inner end of the elastic piece 21k in the vehicle width direction is continuous with the partition wall 21c, and an outer end of the elastic piece 21k in the vehicle width direction is a free end. The outer end of the elastic piece 21k in the vehicle width direction is provided with a lock claw 21m protruding forward in the vehicle length direction toward the handle 25.

Referring to FIGS. 5 and 6, the handle 25 is arranged in the handle arrangement portion 21a so as to be positioned on the vehicle exterior side of the base 21 and is attached to the base 21 via the rotary shaft 27 extending in the vehicle height direction. The handle 25 is rotatable in the directions A1 and A2 by the rotary shaft 27 between an initial position indicated by a solid line and an emergency operation position indicated by a two-dot chain line in FIG. 3 via a normal operation position indicated by a dash-dot line. When the handle 25 is at the initial position indicated by the solid line in FIG. 3, the opening actuation of the latch mechanism 11 illustrated in FIG. 1 is impossible. When the handle 25 is rotated to the normal operation position indicated by the dash-dot line in FIG. 3, the latch mechanism 11 illustrated in FIG. 1 can be electrically actuated to open. When the handle 25 is rotated to the emergency operation position indicated by the two-dot chain line in FIG. 3, the latch mechanism 11 illustrated in FIG. 1 can be manually actuated to open. The handle 25 is biased in a direction A2 toward the initial position indicated by the solid line in FIG. 3 via the transmission lever 30 by a spring biasing the transmission lever 30 illustrated in FIG. 3 in a direction B2.

The key cylinder 45 is provided to manually unlock the lock mechanism 14 in an emergency state. The key cylinder 45 includes a keyhole 45a into which a mechanical key can be inserted. The key cylinder 45 is attached to the attachment frame 21f of the cylinder arrangement portion 21b from the vehicle interior side and is fixed by screwing such that the keyhole 45a is exposed to the vehicle exterior side via the through-hole 21e. Thereby, the key cylinder 45 is arranged adjacent to the rear side of the handle 25 in the vehicle length direction.

Referring to FIGS. 2 and 5, the cover 47 is provided to cover the keyhole 45a of the key cylinder 45 including the through-hole 21e in a normal state. The cover 47 includes a cover main body 47a and an attachment portion 47b, is attached on the vehicle exterior side of the cylinder arrangement portion 21b so as to be openable and closable in the vehicle length direction, and is opened only in an emergency state.

FIGS. 2 to 4, 9 and 10 illustrate a posture in a closed state of the cover 47 covering the keyhole 45a including the through-hole 21e, and FIGS. 5 to 8 illustrate a posture in an open state of the cover 47 in which the keyhole 45a including the through-hole 21e is exposed. Below, the configuration of the cover 47 will be described with reference to a posture in the closed state of the cover 47.

Referring to FIGS. 2, 3, and 5, the cover main body 47a has a shape slightly smaller than the outer wall 21d of the cylinder arrangement portion 21b and exposably covers the keyhole 45a of the key cylinder 45 including the through-hole 21e. The cover main body 47a is formed in a flat plate shape as small as possible within a range in which the keyhole 45a of the key cylinder 45, including the through-hole 21e of the cylinder arrangement portion 21b, and the pair of positioning holes 21h can be covered.

When the cover 47 is in the closed state, an outer surface of the cover main body 47a is flush with an outer surface of the handle 25 and an outer surface of the outer panel 2. A dimension of the cover main body 47a in the vehicle height direction is the same as a dimension of the handle 25 in the vehicle height direction. A clearance as small as possible is secured between the cover main body 47a in the closed state and the handle 25, within a range in which the mechanical key can be inserted. That is, it is difficult to insert a user's finger into the clearance.

Referring to FIGS. 5 to 7 and 9, the attachment portion 47b protrudes from the cover main body 47a toward the vehicle interior side and is movably attached to the attachment hole 21g of the cylinder arrangement portion 21b. The attachment portion 47b is constituted by a pair of leg portions 47c protruding from the cover main body 47a at an interval in the vehicle height direction so as to correspond to the pair of attachment holes 21g. However, the numbers of the attachment holes 21g and the leg portions 47c may be one or three or more, respectively, as long as they can attach the cover 47 so as not to detach.

Each of the leg portions 47c has an L-shape when viewed in the vehicle height direction and is constituted by a first leg portion 47d and a second leg portion 47f.

The first leg portion 47d protrudes in a direction orthogonal to the cover main body 47a. The first leg portions 47d are provided in the vicinity of a rear end of the cover main body 47a in the vehicle length direction and are arranged at an interval so as to be positioned in the vicinity of the upper and lower ends in the vehicle height direction. A cross-sectional shape of the first leg portion 47d taken along a direction orthogonal to a direction in which the first leg portion 47d extends, that is, an XY plane extending in the vehicle length direction and the vehicle height direction in the present embodiment, is smaller than a shape of the attachment hole 21g of the cylinder arrangement portion 21b.

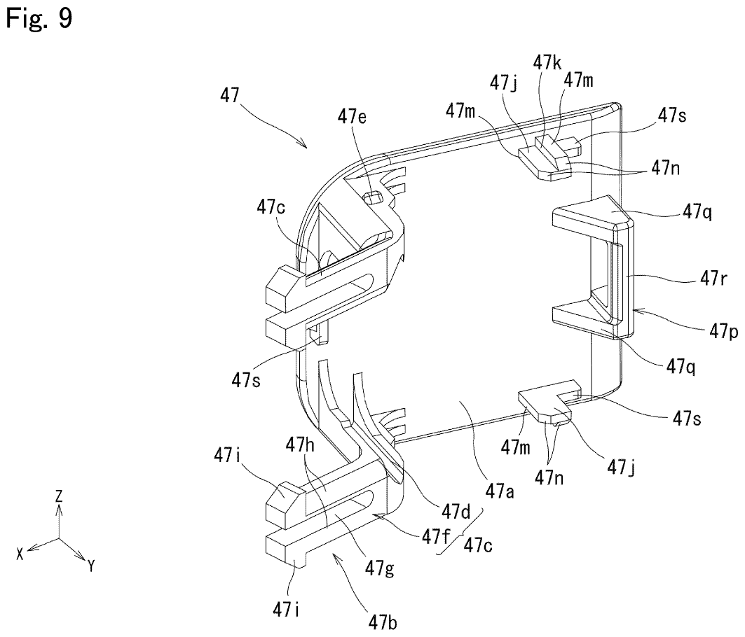

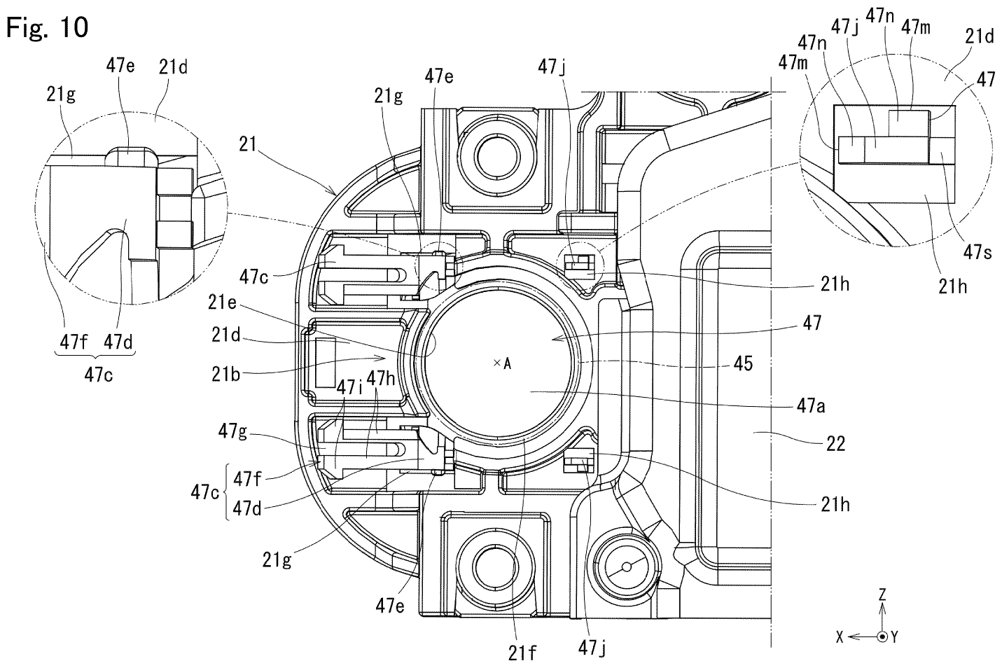

Referring to FIGS. 9 and 10, each of the pair of first leg portions 47d is provided with a locking protrusion 47e, which is locked to an edge of the attachment hole 21g of a surface on the vehicle interior side of the outer wall 21d when the cover 47 is in the closed state. The locking protrusions 47e protrude from an upper surface of the upper first leg portion 47d and a lower surface of the lower first leg portion 47d, respectively. A dimension between top portions of the upper locking protrusion 47e and the lower locking protrusion 47e is larger than a dimension between an upper edge of the upper attachment hole 21g and a lower edge of the lower attachment hole 21g, within a range in which they can pass through the corresponding attachment holes 21g, respectively.

The second leg portion 47f is continuous with an end portion on the vehicle interior side of the first leg portion 47d and protrudes along the cover main body 47a toward the rear side in the vehicle length direction, which is a direction away from the cover main body 47a. The second leg portion 47f is bent with respect to the first leg portion 47d so that an angle formed between the second leg portion 47f and the first leg portion 47d is greater than 90° and is 110° in the present embodiment. A cross-sectional shape of the second leg portion 47f taken along a direction orthogonal to a direction in which the second leg portion 47f extends is smaller than a shape of the attachment hole 21g of the cylinder arrangement portion 21b.

The second leg portion 47f is provided with a pair of second elastic pieces 47h by forming a slit 47g. The slit 47g penetrates the second leg portion 47f in the vehicle width direction and extends from a distal end (an end portion on the rear side in the vehicle length direction) of the second leg portion 47f toward the first leg portion 47d. The pair of second elastic pieces 47h is provided above and below the slit 47g.

Each of the pair of second elastic pieces 47h is provided with a locking claw 47i for suppressing the cover 47 from detaching from the cylinder arrangement portion 21b when the cover 47 is in the open state illustrated in FIG. 5. The locking claw 47i protrudes from the distal end of the second elastic piece 47h toward a side opposite to the slit 47g. That is, the locking claw 47i protrudes upward from the upper second elastic piece of the pair of second elastic pieces 47h and protrudes downward from the lower second elastic piece. A dimension between protruding end portions of the pair of locking claws 47i is smaller than the dimension, in the vehicle height direction, of the attachment hole 21g of the cylinder arrangement portion 21b in a state where the pair of second elastic pieces 47h is bent in a direction approaching each other. On the other hand, the dimension between the protruding end portions of the pair of locking claws 47i is larger than the dimension, in the vehicle height direction, of the attachment hole 21g in a state in which the pair of second elastic pieces 47h is not bent. Thereby, when the cover 47 is in the open state illustrated in FIG. 5, the pair of locking claws 47i is locked to the edge of the attachment hole 21g of the surface on the vehicle interior side of the outer wall 21d and suppresses the cover 47 from detaching.

The cover 47 is further provided with a positioning projection piece 47j, a lock portion 47p, and a stopper 47s, which protrude inward in the vehicle width direction from the cover main body 47a when the cover 47 is in the closed state illustrated in FIG. 2.

The positioning projection piece 47j is provided to position the cover 47 by being inserted into the positioning hole 21h of the cylinder arrangement portion 21b and to restrict movement of the cover 47 in the vehicle length direction and the vehicle height direction. The positioning projection piece 47j has a plate shape extending in the vehicle length direction and the vehicle width direction and is provided on the front side, in the vehicle length direction, of the cover main body 47a, which is an opposite side to the leg portion 47c. The pair of positioning projection pieces 47j is provided at an interval in the vehicle height direction. Each of the pair of positioning projection pieces 47j includes a protruding ridge portion 47k protruding in the vehicle height direction and extending in the vehicle width direction. The protruding ridge portions 47k are provided to protrude upward from the upper positioning projection piece of the pair of positioning projection pieces 47j and to protrude downward from the lower positioning projection piece.

The positioning projection piece 47j including the protruding ridge portion 47k includes a contact portion 47m that can come into contact with a hole edge of the positioning hole 21h of the cylinder arrangement portion 21b. In the present embodiment, an end surface of the positioning projection piece 47j on the rear side in the vehicle length direction and an end surface of the protruding ridge portion 47k on the outer side in the vehicle height direction constitute the contact portions 47m, respectively. The contact portion 47m of the positioning projection piece 47j restricts movement, in the vehicle length direction, of the cover 47 in the closed state by coming into contact with the hole edge of the positioning hole 21h. The contact portion 47m of the protruding ridge portion 47k restricts movement, in the vehicle height direction, of the cover 47 in the closed state by coming into contact with the hole edge of the positioning hole 21h.

The positioning projection piece 47j including the protruding ridge portion 47k is provided with an inclined portion 47n, which can be brought into sliding contact with the hole edge of the positioning hole 21h when the cover 47 is closed from the open state illustrated in FIG. 5 to the closed state illustrated in FIG. 2. Specifically, the inclined portion 47n is provided on each of the positioning projection piece 47j and the protruding ridge portion 47k by chamfering. The inclined portion 47n of the positioning projection piece 47j is provided at a distal end corner portion of the positioning projection piece 47j on the rear side in the vehicle length direction. The inclined portion 47n of the protruding ridge portion 47k is provided at a distal end corner portion of the protruding ridge portion 47k on the outer side in the vehicle height direction.

The lock portion 47p is provided to maintain the cover 47 in the closed state illustrated in FIG. 2. The lock portion 47p protrudes toward the cylinder arrangement portion 21b from a side of the cover main body 47a opposite to the attachment portion 47b so as to be positioned adjacent to the handle 25. The lock portion 47p has a substantially U-shape and includes a pair of first portions 47q protruding inward in the vehicle width direction from the cover main body 47a and a second portion 47r continuous with distal ends of the pair of first portions 47q. When the cover 47 is closed from the open state illustrated in FIG. 5 to the closed state illustrated in FIG. 2, the lock claw 21m of the lock receiving portion 21j is locked to the second portion 47r. Thereby, the lock portion 47p is locked to the lock receiving portion 21j.

The stopper 47s is provided to suppress excessive inward pushing of the cover 47 in the vehicle width direction and to suppress rattling of the cover 47 in the closed state illustrated in FIG. 2. In the present embodiment, three stoppers 47s are provided. One of the three stoppers 47s is provided on the rear side in the vehicle length direction and at the center in the vehicle height direction of the cover main body 47a so as to be positioned between the pair of leg portions 47c. The remaining two of the three stoppers 47s are continuous with the pair of positioning projection pieces 47j and protrude forward in the vehicle length direction. When the cover 47 is in the closed state illustrated in FIG. 2, these stoppers 47s are in contact with the outer wall 21d of the cylinder arrangement portion 21b. In addition, the outer wall 21d of the cylinder arrangement portion 21b is sandwiched between the stopper 47s and the locking protrusion 47e.

In the door handle device 20 configured as described above, in an emergency state, a user operates the rear-side portion 25a of the handle 25 inward in the vehicle width direction and then inserts the mechanical key between the handle 25 and the cover 47. Subsequently, the user operates the mechanical key to move the lock claw 21m rearward in the vehicle length direction. Thereby, locking of the lock portion 47p by the lock receiving portion 21j is released. Further, the locking protrusion 47e of the cover 47 rides over the hole edge of the attachment hole 21g of the cylinder arrangement portion 21b, and the cover main body 47a moves outward in the vehicle width direction.

Subsequently, the user pinches the cover main body 47a with his/her fingers and operates it outward in the vehicle width direction. Thereby, the first leg portion 47d of the cover 47 moves outward in the vehicle width direction with respect to the attachment hole 21g of the cylinder arrangement portion 21b, and then the second leg portion 47f moves outward in the vehicle width direction with rotation. This movement is stopped when the locking claw 47i of the cover 47 is locked to the periphery of the attachment hole 21g of the cylinder arrangement portion 21b. As a result, the cover 47 can be brought into the open state illustrated in FIG. 5 with respect to the cylinder arrangement portion 21b.

In the open state of the cover 47 illustrated in FIG. 5, the keyhole 45a of the key cylinder 45 is exposed. Therefore, the user can manually switch the lock mechanism 14 illustrated in FIG. 1 from the locked state to the unlocked state by inserting the mechanical key into the keyhole 45a and operating the key cylinder 45.

On the other hand, when switching the cover 47 from the open state illustrated in FIG. 5 to the closed state illustrated in FIG. 2, the user pinches the cover main body 47a and operates it inward in the vehicle width direction. Thereby, the second leg portion 47f of the cover 47 moves inward in the vehicle width direction with respect to the attachment hole 21g of the cylinder arrangement portion 21b, and then the first leg portion 47d moves inward in the vehicle width direction with rotation.

Subsequently, when the cover main body 47a is positioned along the outer wall 21d of the cylinder arrangement portion 21b, the user pushes the cover main body 47a inward in the vehicle width direction. Thereby, the locking protrusion 47e of the cover 47 rides over the hole edge of the attachment hole 21g of the cylinder arrangement portion 21b and is locked to the inner surface of the outer wall 21d. Further, the lock portion 47p of the cover 47 is locked to the lock receiving portion 21j of the cylinder arrangement portion 21b. Thereby, the cover 47 can be brought into the closed state in which it is difficult to open the cover 47 with respect to the cylinder arrangement portion 21b.

The door handle device 20 configured as described above has the following features.

The attachment hole 21g for attaching the attachment portion 47b of the cover 47 is provided such that at least a part thereof is positioned between the first reference line L1 passing through the upper end of the through-hole 21e through which the keyhole 45a is exposed and the second reference line L2 passing through the lower end of the through-hole 21e. For this reason, the cover main body 47a can be made as small as possible within a range in which the keyhole 45a of the key cylinder 45 including the through-hole 21e can be covered. Therefore, an occupying area necessary to form the cylinder arrangement portion 21b can also be made as narrow as possible within a range in which the cover 47 can be arranged. As a result, the cover 47 of the key cylinder 45 and the cylinder arrangement portion 21b of the base 21 can be downsized, and thus the entire door handle device 20 can be downsized.

Of the leg portion 47c constituting the attachment portion 47b, the first leg portion 47d protruding from the cover main body 47a is provided with the locking protrusion 47e to be locked to the edge of the attachment hole 21g. For this reason, the closed state in which the keyhole 45a of the key cylinder 45 including the through-hole 21e is covered with the cover 47 can be maintained by the locking protrusion 47e, and the lifting of the cover main body 47a can be prevented.

The second leg portion 47f includes the pair of second elastic pieces 47h, and each of the pair of second elastic pieces 47h is provided with the locking claw 47i protruding to a side opposite to the slit 47g. Thereby, when the pair of second elastic pieces 47h is bent in a direction approaching each other, the leg portion 47c can be easily inserted into and attached to the attachment hole 21g. In addition, in a state in which the leg portion 47c is inserted into the attachment hole 21g, the cover 47 can be effectively prevented from detaching by the locking claws 47i.

The cover main body 47a is provided with the positioning projection piece 47j, the cylinder arrangement portion 21b is provided with the positioning hole 21h, and the positioning projection piece 47j includes the contact portion 47m that can come into contact with the hole edge of the positioning hole 21h. Thereby, in a state in which the keyhole 45a of the key cylinder 45 including the through-hole 21e is covered with the cover main body 47a, the cover main body 47a can be positioned with respect to the cylinder arrangement portion 21b by the contact of the contact portion 47m with the hole edge of the positioning hole 21h. Therefore, rattling of the cover 47 in the closed state can be suppressed.

The positioning projection piece 47j of the cover 47 is provided with the inclined portion 47n, which can be brought into sliding contact with the hole edge of the positioning hole 21h of the cylinder arrangement portion 21b. Thereby, when the cover main body 47a is rotated about the leg portion 47c as a fulcrum to insert the positioning projection piece 47j into the positioning hole 21h of the cylinder arrangement portion 21b, the inclined portion 47n is brought into sliding contact with the hole edge of the positioning hole 21h. For this reason, it is possible to improve workability when covering the keyhole 45a of the key cylinder 45 including the through-hole 21e with the cover main body 47a.

The cover main body 47a is provided with the lock portion 47p, and the cylinder arrangement portion 21b is provided with the lock receiving portion 21j for locking the lock portion 47p. Thereby, when the cover main body 47a is rotated about the leg portion 47c as a fulcrum to lock the lock portion 47p to the lock receiving portion 21j, the keyhole 45a of the key cylinder 45 including the through-hole 21e can be reliably maintained in a state of being covered with the cover main body 47a.

The lock portion 47p and the lock receiving portion 21j are provided adjacent to the handle 25, and the outer surface of the handle 25 and the outer surface of the cover main body 47a are flush with each other. This makes it difficult to unlock the lock portion 47p and the lock receiving portion 21j and open the cover 47 with respect to the cylinder arrangement portion 21b. Therefore, in a normal state in which the key cylinder 45 is not used, unintended opening of the cover 47 can be suppressed.

Note that the present invention is not limited to the configuration of the above-described embodiment, and various modifications can be made.

For example, the cover 47 may be attached to the cylinder arrangement portion 21b so as to be openable and closable in the vehicle height direction. In this case, in FIG. 8, the attachment hole 21g of the cylinder arrangement portion 21b is provided such that at least a part thereof is positioned between a third reference line L3 passing through a left end of the through-hole 21e and extending in an upper-lower direction and a fourth reference line L4 passing through a right end of the through-hole 21e and extending in the upper-lower direction.

The positioning projection piece 47j may be provided on the cylinder arrangement portion 21b, and the positioning hole 21h may be provided in the cover main body 47a. In this case, it is preferable that the positioning hole 21h formed in the cover main body 47a is constituted by a recess portion recessed from the vehicle interior side toward the vehicle exterior side in the closed state illustrated in FIG. 3 and not penetrating in the vehicle width direction.

The lock portion 47p may be provided on the cylinder arrangement portion 21b, and the lock receiving portion 21j may be provided on the cover main body 47a.

What is claimed is:

1. A door handle device comprising:
a base including a handle arrangement portion and a cylinder arrangement portion and to be attached to a door, the cylinder arrangement portion provided adjacent to the handle arrangement portion and including a through-hole penetrating from a vehicle exterior side to a vehicle interior side;
a handle rotatably attached to the handle arrangement portion so as to be exposed to the vehicle exterior side of the door and configured to operate a door latch device attached to the door to open;
a key cylinder attached to the cylinder arrangement portion such that a keyhole is exposed to the vehicle exterior side via the through-hole and configured to operate the door latch device to unlock; and
a cover attached to the vehicle exterior side of the cylinder arrangement portion, wherein
the cover includes a cover main body configured to exposably cover the keyhole including the through-hole, and an attachment portion protruding from the cover main body,
the cylinder arrangement portion is provided with an attachment hole for attaching the attachment portion, and
the attachment hole is provided such that at least a part of the attachment hole is positioned between a first reference line passing through an upper end of the through-hole and extending in a left-right direction and a second reference line passing through a lower end of the through-hole and extending in the left-right direction or between a third reference line passing through a left end of the through-hole and extending in an upper-lower direction and a fourth reference line passing through a right end of the through-hole and extending in the upper-lower direction, as seen along a direction in which an axis line of the through-hole extends.

2. The door handle device according to claim 1, wherein
the attachment portion includes a pair of leg portions protruding from the cover main body,
each of the pair of leg portions includes a first leg portion protruding in a direction intersecting the cover main body and a second leg portion continuous with an end portion of the first leg portion on the vehicle interior side and protruding in a direction away from the cover main body along the cover main body, and is movably attached relative to the attachment hole, and
the first leg portion is provided with a locking protrusion that is locked to an edge of the attachment hole when the keyhole including the through-hole is covered with the cover main body.

3. The door handle device according to claim 2, wherein
the second leg portion includes a slit extending from a tip end of the second leg portion toward the first leg portion, and a pair of elastic pieces positioned on both sides of the slit, and
each of the pair of elastic pieces is provided with a locking claw protruding toward a side opposite to the slit.

4. The door handle device according to claim 1, wherein
one of the cover main body and the cylinder arrangement portion is provided with a positioning projection piece protruding toward the other of the cover main body and the cylinder arrangement portion,
the other of the cover main body and the cylinder arrangement portion is provided with a positioning hole into which the positioning projection piece is to be inserted, and
the positioning projection piece includes a contact portion that is to be brought into contact with a hole edge of the positioning hole.

5. The door handle device according to claim 4, wherein the positioning projection piece is provided with an inclined portion that is to be brought into sliding contact with the hole edge of the positioning hole.

6. The door handle device according to claim 1, wherein
one of the cover main body and the cylinder arrangement portion is provided with a lock portion protruding from a side opposite to the attachment portion toward the other of the cover main body and the cylinder arrangement portion, and
the other of the cover main body and the cylinder arrangement portion is provided with a lock receiving portion configured to lock the lock portion.

7. The door handle device according to claim 6, wherein
the attachment hole is provided on a side opposite to the handle arrangement portion with respect to the through-hole,
the lock portion and the lock receiving portion are provided adjacent to the handle, and
an outer surface of the handle and an outer surface of the cover main body are flush with each other.

8. The door handle device according to claim 2, wherein
one of the cover main body and the cylinder arrangement portion is provided with a positioning projection piece protruding toward the other of the cover main body and the cylinder arrangement portion,
the other of the cover main body and the cylinder arrangement portion is provided with a positioning hole into which the positioning projection piece is to be inserted, and
the positioning projection piece includes a contact portion that is to be brought into contact with a hole edge of the positioning hole.

9. The door handle device according to claim 8, wherein the positioning projection piece is provided with an inclined portion that is to be brought into sliding contact with the hole edge of the positioning hole.

10. The door handle device according to claim 3, wherein
one of the cover main body and the cylinder arrangement portion is provided with a positioning projection piece protruding toward the other of the cover main body and the cylinder arrangement portion,
the other of the cover main body and the cylinder arrangement portion is provided with a positioning hole into which the positioning projection piece is to be inserted, and
the positioning projection piece includes a contact portion that is to be brought into contact with a hole edge of the positioning hole.

11. The door handle device according to claim 10, wherein the positioning projection piece is provided with an inclined portion that is to be brought into sliding contact with the hole edge of the positioning hole.

12. The door handle device according to claim 2, wherein
one of the cover main body and the cylinder arrangement portion is provided with a lock portion protruding from a side opposite to the attachment portion toward the other of the cover main body and the cylinder arrangement portion, and
the other of the cover main body and the cylinder arrangement portion is provided with a lock receiving portion configured to lock the lock portion.

13. The door handle device according to claim 12, wherein
the attachment hole is provided on a side opposite to the handle arrangement portion with respect to the through-hole,
the lock portion and the lock receiving portion are provided adjacent to the handle, and
an outer surface of the handle and an outer surface of the cover main body are flush with each other.

14. The door handle device according to claim 3, wherein
one of the cover main body and the cylinder arrangement portion is provided with a lock portion protruding from a side opposite to the attachment portion toward the other of the cover main body and the cylinder arrangement portion, and
the other of the cover main body and the cylinder arrangement portion is provided with a lock receiving portion configured to lock the lock portion.

15. The door handle device according to claim 14, wherein
the attachment hole is provided on a side opposite to the handle arrangement portion with respect to the through-hole,
the lock portion and the lock receiving portion are provided adjacent to the handle, and
an outer surface of the handle and an outer surface of the cover main body are flush with each other.
